(19) United States
(12) Patent Application Publication
(10) Pub. No.: US 2023/0322188 A1
(43) Pub. Date: Oct. 12, 2023

(54) CONNECTION DEVICE FOR A VEHICLE WIPER SYSTEM

(71) Applicant: Valeo Systèmes d'Essuyage, Le Mesnil Saint Denis (FR)

(72) Inventors: Gerald Caillot, Le Mesnil Saint Denis (FR); Vincent Izabel, Le Mesnil Saint Denis (FR)

(73) Assignee: Valeo Systèmes d'Essuyage, Le Mesnil Saint Denis (FR)

(21) Appl. No.: 18/018,703

(22) PCT Filed: Jul. 23, 2021
(86) PCT No.: PCT/EP2021/070759

§ 371 Date: Jan. 30, 2023

(30) Foreign Application Priority Data
Jul. 30, 2020 (FR) FR2008135

(51) Int. Cl. B60S 1/40

(52) U.S. Cl. CPC B60S 1/4016

(57) ABSTRACT

A connection device for a wiper system for wiping a glazed surface of a vehicle is disclosed. The wiper system includes at least one wiper, and at least one wiper arm designed to drive the rotation of the wiper. The connection device connects the wiper to the wiper arm and further includes at least one connector configured to be secured to the wiper and at least one adapter mounted with the ability to pivot on the connector. The wiper arm extends between a first end designed to be connected to a motor and a second end designed to be secured to the adapter. The adapter and the connector define a closed-section housing for receiving at least part of the second end of the wiper arm. This part of the second end of the wiper arm is configured to contribute to holding the adapter on the connector.

The field of the present invention concerns wiper systems intended for vehicles, and in particular for motor vehicles. More particularly, the present invention relates to connection devices of these wiper systems.

Motor vehicles are commonly equipped with wiper systems for wiping their glazed surfaces, and, in particular, their windshields. Such wiper systems conventionally comprise at least one wiper intended to wipe the glazed surface in question, a wiper arm for driving the wiper in rotation and a connection device which connects the wiper arm to the wiper.

The connection device comprises at least one connector secured to the wiper and at least one adapter mounted so as to rotate on the connector. The wiper arm for its part extends between a first end, by which it is connected to a motor carried by the vehicle, which makes it possible to drive the wiper arm in rotation, and a second end, by which it is connected to the connection device, and more particularly to the adapter of this connection device.

There currently exist different types of connection between the wiper arm and the adapter. Known in particular are wiper arms of which the second end is in the form of a hook, the radius of curvature of which is inscribed in a plane perpendicular, or substantially perpendicular, to a main extension plane of the glazed surface to be wiped.

A drawback of the currently known connection devices resides in the need to fit means for keeping the adapter on the connector in order to ensure a reliable connection between these two parts and therefore, as a result, also between the wiper arm and the wiper, while allowing the adapter to pivot with respect to the connector. Such a connection should be sufficiently strong to avoid any accidental detachment of these parts, which could be dangerous to the user of the vehicle if this detachment were to occur during wiping for example.

Furthermore, a drawback of the use of wiper arms having a hook as described above resides in the size of these hooks, in particular in terms of height, that is to say along a direction perpendicular to the extension plane of the glazed surface to be wiped. Moreover, this shape results in a relatively large distance between the glazed surface and the wiper arm, this presenting at least one aesthetic problem and also disturbing the flow of air when the vehicle which comprises said glazed surface is moving.

The present invention falls within this context by proposing a connection device designed to be used in a wiper system in which the wiper arm is improved compared with the existing solutions, this connection device making it possible to connect the improved wiper arm to the corresponding wiper.

One subject of the present invention thus relates to a connection device for a wiper system for wiping a glazed surface of a vehicle, intended to connect a wiper to a wiper arm configured to drive the wiper in rotation, the connection device comprising at least one connector configured to be secured to the wiper and at least one adapter mounted so as to pivot on the connector, the connector comprising a base forming the part of the connector configured to secure it to the wiper and a main body forming a vertical protuberance intended to cooperate with the adapter in order to form the connection device, the adapter and the connector defining, together, a housing of closed cross section designed to receive at least one part of a second end of the wiper arm.

According to the invention, the connection device comprises a groove provided in the connector, this groove helping to delimit the housing of closed cross section configured to receive the at least one part of the second end of the wiper arm, the groove being recessed into the thickness of the main body of the connector.

According to the invention, the housing of closed cross section which is configured to receive the at least one part of the second end of the wiper arm has a closed cross section, as seen in a vertical plane. The second end of the wiper arm thus has at least one part which is positioned in a volume defined between the connector and the adapter so as to prevent the relative movement of the adapter with respect to the connector, and more particularly the relative movement of the adapter with respect to the connector, along a pivot axis of the adapter with respect to the connector. Advantageously, the connection between the adapter and the connector is thus ensured without an additional part needing to be added, this connection allowing at least one degree of freedom between the connector and the adapter, however.

According to the invention, a groove is provided in the connector, this groove helping to delimit the housing of closed cross section configured to receive the at least one part of the second end of the wiper arm. In other words, the housing of closed cross section configured to receive the at least one part of the second end of the wiper arm is created by a structural modification of the connector and of the adapter compared with known connectors and adapters.

According to an optional feature of the invention, the connection device comprises means for pivoting the adapter with respect to the connector. For example, these pivoting means comprise at least one lug provided on one of the adapter and the connector, and at least one orifice provided in the other of the adapter and the connector, the lug being received in the orifice.

According to one feature of the invention, the adapter comprises at least one first side wall and at least one second side wall which are connected together by at least one upper wall, the first side wall, the second side wall and the upper wall defining an internal space in the adapter, in which, at least, a part of the connector is received.

According to one exemplary embodiment of the present invention, at least one tab extends from the upper wall of the adapter, into the internal space in the adapter and along a direction transverse to a main extension plane of the upper wall, this at least one tab bearing the at least one lug and this at least one tab being separate from the side walls of the adapter. Advantageously, the tab extends perpendicularly to the main extension plane of the upper wall. According to this exemplary embodiment, the at least one tab extends, at least partially, in the groove which is provided in the connector and the bottom of which helps to define the housing of closed cross section configured to receive the at least one part of the second end of the wiper arm. In other words, the at least one tab extends, at least partially, in the housing of closed cross section configured to receive the at least one part of the second end of the wiper arm such that this part of the second end of the wiper arm makes it possible to prevent the tab from moving, and consequently also to avoid disengagement of the lug borne by this tab from the orifice which receives this lug. In doing so, that part of the second end of the wiper arm that is received in the housing of closed cross section makes it possible to secure the connection created between the adapter and the connector.

Optionally, the at least one tab may comprise at least one rod which extends from the tab along a direction transverse to a main extension direction of the tab, the at least one part of the second end of the wiper arm that is received in the housing of closed cross section being designed to be arranged so as to bear against this rod. Advantageously, the rod extends perpendicularly to the main extension direction of the tab that bears it. It will be understood from the foregoing that this rod thus extends in the housing of closed cross section defined between the connector and the adapter, such that the at least one part of the second end of the wiper arm can come to bear on this rod. For example, the at least one tab may have an internal face, facing the internal space in the adapter and facing away from an external face of this tab, the external face bearing the at least one lug and the rod being provided on the internal face. Thus, the at least one part of the second end of the wiper arm that is received in the housing of closed cross section may be arranged so as to bear against the rod, and therefore, indirectly, against the internal face, thereby making it possible to keep the lug provided on the external face of this tab in the orifice that receives it.

According to one feature of this exemplary embodiment of the invention, the at least one tab may be a first tab that bears the rod and a first lug received in a first orifice provided in the connector, and a second tab that bears a second lug received in a second orifice provided in the connector may extend from the upper wall of the adapter, along a direction transverse to the main extension plane of the upper wall, the at least one part of the second end of the wiper arm that is received in the housing of closed cross section being configured to be arranged in contact with the first tab, if necessary, via the rod, and with the second tab. For example, the first tab and second tab may both extend perpendicularly to the main extension plane of the upper wall of the adapter, meaning that the first tab and the second tab then extend along two main directions that are parallel to one another.

For example, the first tab is as described above, and the second tab likewise comprises an external face bearing the second lug and an internal face against which the part of the second end of the wiper arm that is received in the housing of closed section bears. Thus, this part of the second end of the wiper arm is configured to both keep the first lug in the first orifice, by indirectly bearing on the first tab via the rod, and the second lug in the second orifice, by indirectly bearing on the internal face of the second tab. The pivoting means can thus be kept in cooperation, ensuring optimal operation of a wiper system comprising the connection device according to the invention.

It will be understood that the terms “first tab” and “second tab” are used only to make it easier to understand the description and that the rod could be provided on the second tab without detracting from the invention.

It follows from the foregoing that, according to this exemplary embodiment of the present invention, the housing of closed cross section configured to receive the part of the second end of the wiper arm also receives, at least partially, the first tab and the second tab that bear the first and second lugs.

According to another exemplary embodiment of the present invention, the at least one lug that helps to form the means for pivoting the adapter with respect to the connector may be provided on one of the side walls of the adapter. Optionally, at least one first lug may be provided on the first side wall and a second lug may, for its part, be provided on the second side wall, the first lug being received in a first orifice provided in the connector and the second lug being received in a second orifice provided in the connector. For example, at least the first orifice may be provided in a wall of the connector which helps to delimit the groove provided in the connector. Advantageously, the first orifice and the second orifice are both provided in walls of the connector that delimit this groove. The first lug and the second lug may, for their part, be provided for example on internal faces of the side walls of the adapter, that is to say faces of these walls that face the internal space in this adapter. It will be understood that these are only exemplary embodiments which should not be understood as limiting the invention.

According to one feature of this exemplary embodiment of the invention, the adapter comprises at least one coupling tongue designed to receive a part of the wiper arm, this coupling tongue extending between a first end, by which it is secured to the adapter, and a second, free end.

In other words, this coupling tongue is configured to secure the second end of the wiper arm to the adapter.

For example, this coupling tongue extends mainly along a direction parallel to a main extension axis of the wiper, away from the front face of the connection device. This coupling tongue extends between a first end, by which it is secured to the adapter, and a second, free end. This second, free end may advantageously comprise at least one holding member for keeping the first segment of the wiper arm in position. It will be understood that this is only one exemplary embodiment, and that this at least one holding member could be provided between the first end and the second end of the coupling tongue without departing from the scope of the present invention.

The present invention also relates to a wiper system of a vehicle, comprising at least one wiper designed to wipe a glazed surface of the vehicle, at least one wiper arm designed to drive the wiper in rotation and at least one connection device as described above, which is designed to connect the wiper to the wiper arm.

According to one feature of this exemplary embodiment, the wiper arm extends between a first end designed to be connected to a motor carried by the vehicle and a second end designed to be secured to the adapter, the second end of the wiper arm has a hook shape, at least a part of the hook is received in the housing of closed cross section, and this at least one part of the hook helps to keep the adapter on the connector. Advantageously, the hook forming the second end of the wiper arm does not extend all around the adapter but is engaged in the volume of the housing of closed cross section. As mentioned above, the connection between the adapter and the connector is thus ensured without an additional part needing to be added, this connection allowing at least one degree of freedom between the connector and the adapter, however.

According to one feature of the invention, the wiper arm is configured to pivot about a main axis of rotation, the hook of the wiper arm having a radius of curvature which is inscribed in a plane perpendicular to the main axis of rotation of this wiper arm. In other words, a profile of this hook forming the second end of the wiper arm is inscribed in the plane perpendicular to the main axis of rotation of the wiper arm, this plane also be parallel, or substantially parallel, to the glazed surface of the vehicle equipped with the wiper system according to the invention. Advantageously, such a radius of curvature makes it possible to limit the vertical size, that is to say the size along a direction parallel to the main axis of rotation of the wiper arm, of the connection device that receives, at least partially, this hook. This radius of curvature also makes it possible to free up a rear face of the connection device, that is to say not to overlie this rear face of the connection device so as to make it possible, for example, to create a connection to a pipe for conveying a washer fluid. The “rear face of the connection device” is understood to be a face of this connection device that faces the first end of the wiper arm.

The hook forming the second end of the wiper arm may be in the shape of a U comprising at least one first segment and at least one second segment that are connected together by a base, the at least one first segment forming a continuation of a main body of the wiper arm and the at least one second segment forming a free end of the hook, the at least one part of the hook of the wiper arm that is received in the housing of closed cross section being formed, at least, by the second segment of the hook. In other words, the second segment of the hook forms the part of this hook that helps to keep the adapter on the connector. The main body of the wiper arm extends between the first segment of the U shape adopted by the hook of the wiper arm and the first end of this wiper arm, which, for its part, is designed to be connected to the motor carried by the vehicle.

According to one feature of the invention, the connection device extends, mostly, between a front face and a rear face, the front face facing away from the first end of the wiper arm, and the base of the U shape adopted by the hook of the wiper arm is arranged next to the front face of the connection device. Advantageously, the housing of closed cross section that receives the second segment of the hook may open onto the front face of the connection device. Such an arrangement thus makes it possible to insert the hook into the connection device via its front face, making it easy to mount the wiper arm on the adapter.

According to one feature of the invention, the internal space of the adapter may receive, at least, the second segment of the hook of the wiper arm, the second side wall of the adapter being clamped, or in other words sandwiched, between the connector and the first segment of the hook of the wiper arm.

As mentioned above, the second segment of the hook of the wiper arm forms the part of the second end of this wiper arm that is received in the housing of closed cross section. According to one feature of the invention, this second segment of the hook of the wiper arm helps to keep the lug in the orifice. As a result, the cooperation between the lug and the orifice helps to form a pivot axis of the adapter with respect to the connector. Advantageously, the pivoting means comprise a first lug of the adapter that is received in a first orifice of the connector and a second lug of the adapter that is received in a second orifice of the connector. The pivot axis of the adapter with respect to the connector can thus be realized by a straight line passing through the first lug and through the second lug, this straight line also passing through a center of the first orifice and through a center of the second orifice, in which the lugs are received.

According to the other exemplary embodiment mentioned above, in which the at least one lug helping to form the means for pivoting the adapter with respect to the connector is provided on one of the side walls of the adapter, the second segment of the hook of the wiper arm is received in the groove provided in the connector, while the first segment of this hook borders, laterally, the connection device. Thus, if the first lug borne by the first side wall of the adapter starts to disengage from the first orifice that receives it, the second segment of the hook is driven in the direction of this first side wall, until it comes into abutment against a lateral side of the groove, thereby preventing full disengagement of this first lug from the first orifice. Analogously, if the second lug borne by the second side wall starts to disengage from the second orifice that receives it, the second segment of the hook is driven in the direction of this second side wall, until it comes into abutment against another lateral side of the groove, thereby likewise preventing full disengagement of the second lug from the second orifice. The second segment of the hook therefore clearly helps here to keep the lugs in their respective orifices and therefore, likewise, to keep the adapter on the connector.

As mentioned above, the at least one tab which extends from the upper wall of the adapter may comprise at least one rod which extends from the tab along a direction transverse to a main extension direction of the tab, the second segment of the hook of the wiper arm being arranged so as to bear against this rod.

As mentioned above, the second segment of the hook of the wiper arm helps to keep the adapter on the connector, meaning that it helps to keep the lugs in their respective orifices, thereby preventing the relative movement of the adapter with respect to the connector, in particular along the pivot axis of this adapter with respect to the connector.

According to one feature of the invention, the adapter may comprise at least one coupling tongue designed to receive a part of the first segment of the hook of the wiper arm. In other words, this coupling tongue helps to secure the second end of the wiper arm to the adapter.

For example, this coupling tongue extends mainly along a direction parallel to a main extension axis of the wiper, away from the front face of the connection device. This coupling tongue extends between a first end, by which it is secured to the adapter, and a second, free end. This second, free end may advantageously comprise at least one holding member for keeping the first segment of the wiper arm in position. It will be understood that this is only one exemplary embodiment, and that this at least one holding member could be provided between the first end and the second end of the coupling tongue without departing from the scope of the present invention.

For example, the at least one holding member may comprise a tooth which cooperates with a first cutout provided in the first segment of the wiper arm, for example by elastic snap-fastening. Alternatively or additionally, this at least one holding member may comprise two fingers which each continue, laterally, an edge of the coupling tongue, these two fingers being designed to sandwich the first segment of the hook of the wiper arm. For example, each of these fingers may extend along a main direction perpendicular to a main extension plane of the coupling tongue.

According to one particular arrangement in which the at least one holding member is formed by the tooth and by the two fingers, the tooth is advantageously provided between these two fingers. In other words, according to this particular arrangement, the first segment of the hook of the wiper arm is sandwiched between the two abovementioned fingers, next to the cutout with which the tooth cooperates. In other words, according to this particular arrangement, the two fingers and the tooth which form the holding member are aligned along one and the same axis and this holding member is consequently engaged with the first segment of the hook in a single region of this first segment. For example, the coupling tongue continues the second side wall of the adapter.

According to one example of the present invention, the upper wall extends laterally beyond the second side wall, away from the internal space, and the adapter comprises at least one lower wall which extends from a lower edge of the second side wall, laterally, away from the internal space such that the upper wall, the second side wall and the lower wall define a region for receiving the first segment of the hook of the wiper arm. According to one example of the invention, this lateral continuation of the upper wall is realized only on one side of the adapter. Optionally, a height of the second side wall, measured between the upper wall and the lower wall of the adapter, perpendicularly to a main extension plane of the upper wall, and a thickness of the first segment of the hook are identical, or substantially identical. More particularly, the height of the second side wall is measured between the protrusions formed respectively by the upper wall and the lower wall, beyond the second side wall.

According to one particular exemplary embodiment of the present invention, at least one damping member is carried by the wiper arm. Advantageously, this damping member makes it possible to protect the glazed surface that the wiper system is intended to wipe in the case of poor manipulation of the wiper arm, in particular during replacement of the wiper and when the new wiper has not yet been mounted on the arm, which would result in the latter dropping and the free end of the arm coming into contact with the glazed surface. For example, the at least one damping member is mounted on the first segment of the hook of the wiper arm. Advantageously, the damping member covers at least the first segment of the hook of the wiper arm. Optionally, the damping member may also cover at least a part of the base of this hook.

Advantageously, the wiper system according to the invention may comprise at least one duct for conveying a washer fluid, which is designed to be connected hydraulically to a tank of washer fluid carried by the vehicle, this conveying duct being hydraulically connected to a hydraulic connecting member provided on the rear face of the connection device. This connecting member may in this case be arranged on the rear face of the connection device since, on account of the shape of the hook forming the second end of the wiper arm, the first segment of this hook extends laterally with respect to the connection device, thereby opening up the “vertical” access to the rear face of the connection device. In other words, the fact that the radius of curvature of the hook extends in the plane parallel to the glazed surface makes it possible, as mentioned above, for the wiper arm not to overlie the rear face of the connection device, thereby allowing the connection of the connecting member to this rear face.

Alternatively, the conveying duct may be hydraulically connected to a cannula arranged on the damping member, this cannula being itself connected to at least one spray nozzle carried by this damping member and designed to spray the washer fluid onto the glazed surface in question.

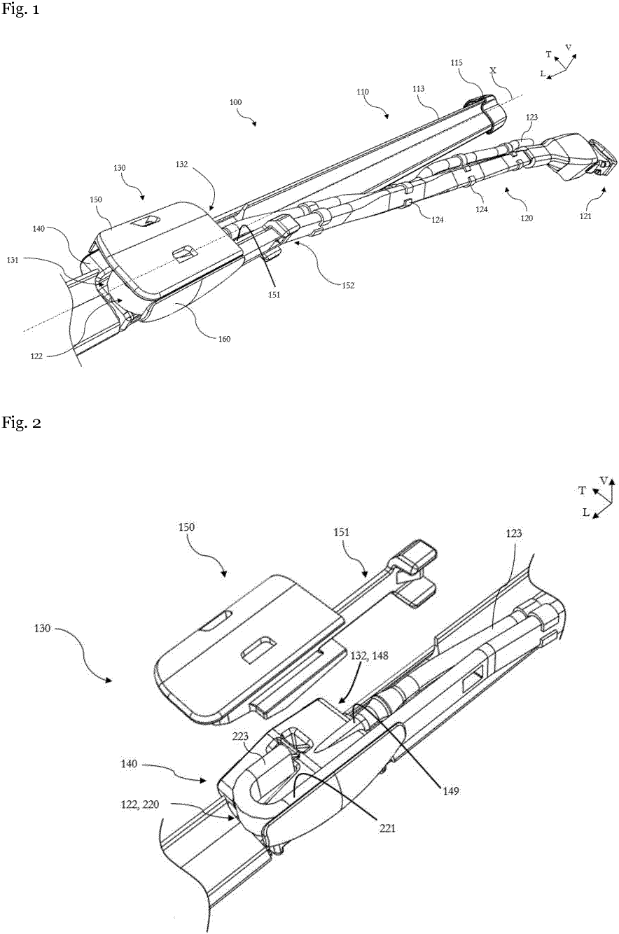

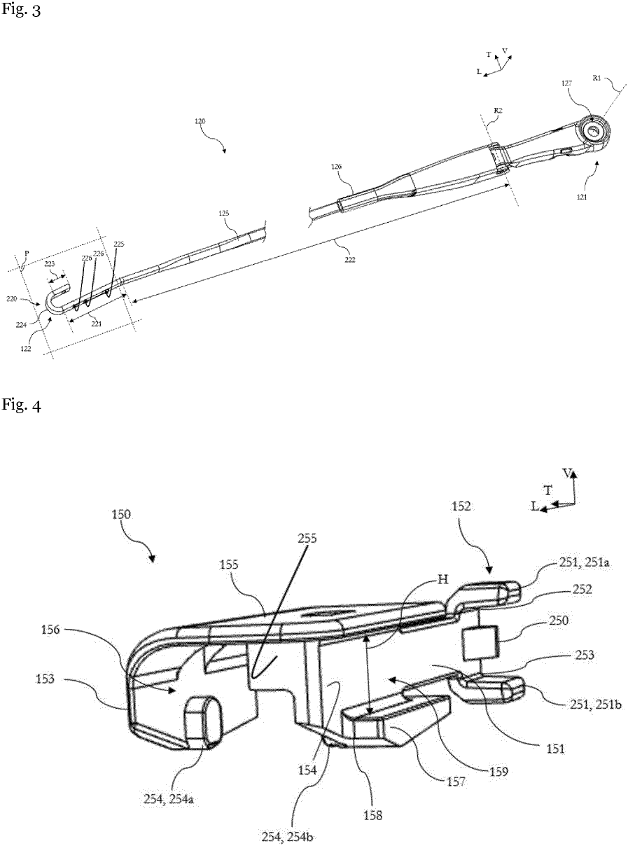

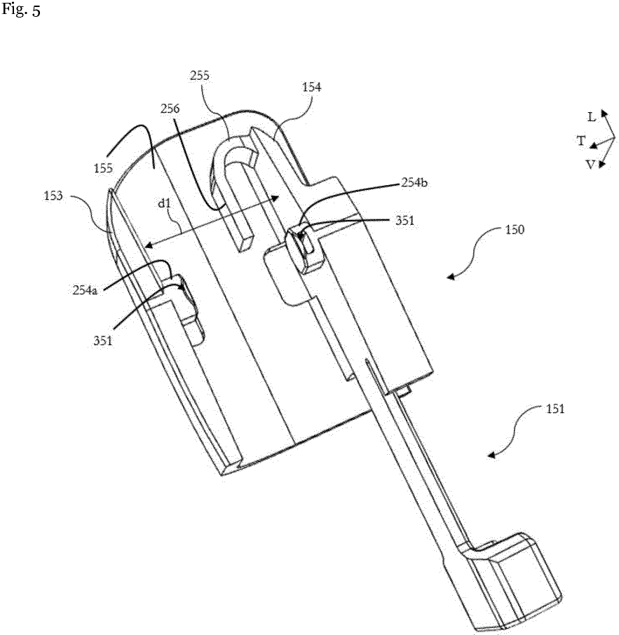

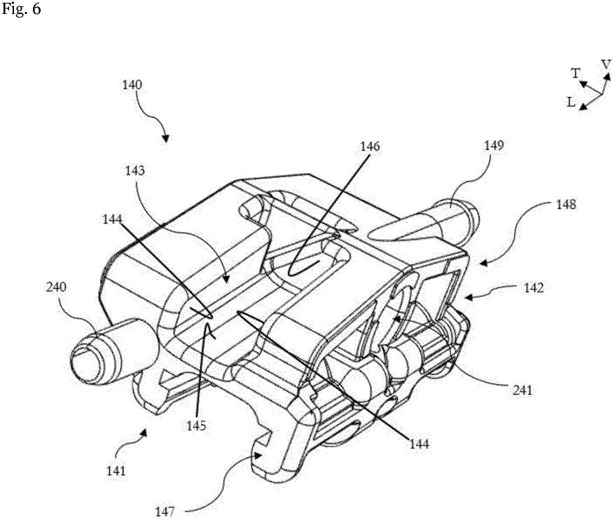

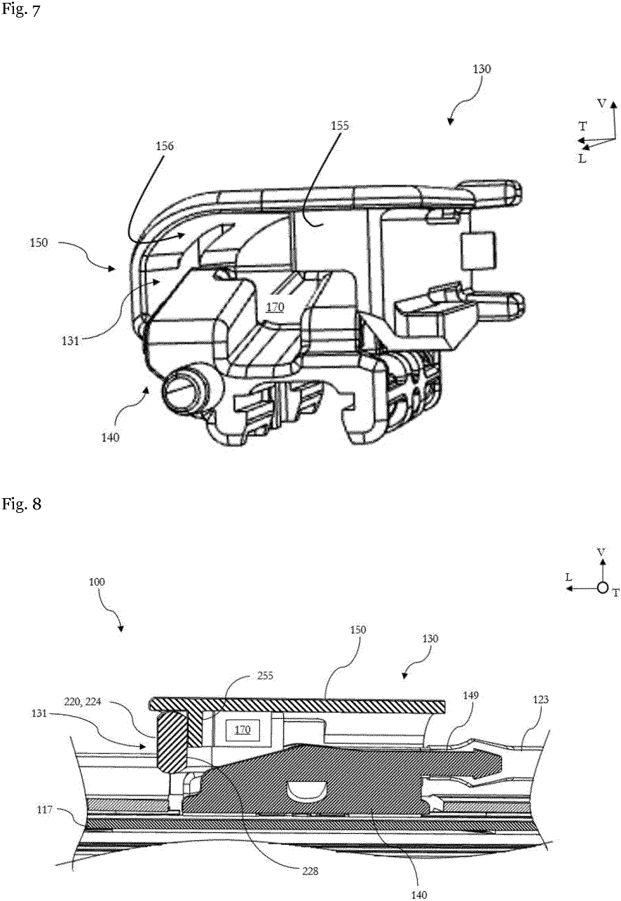

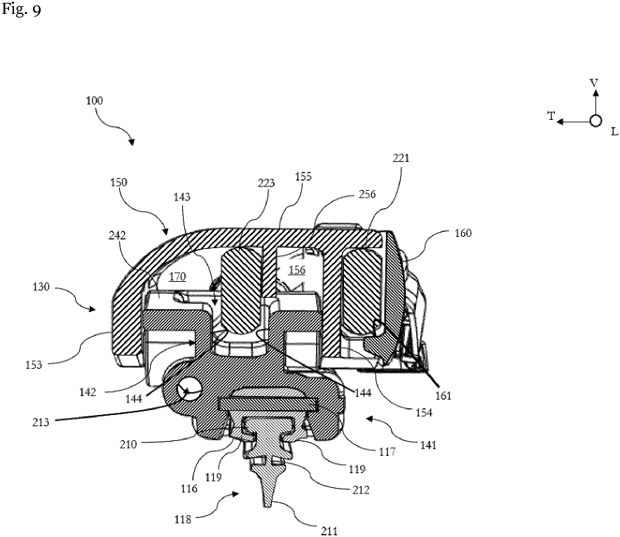

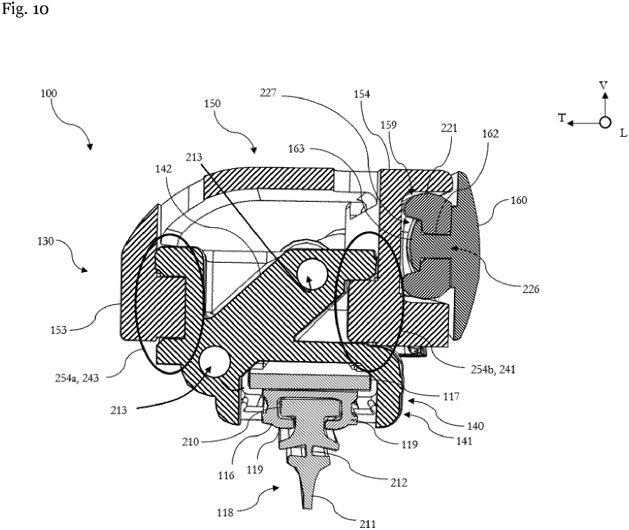

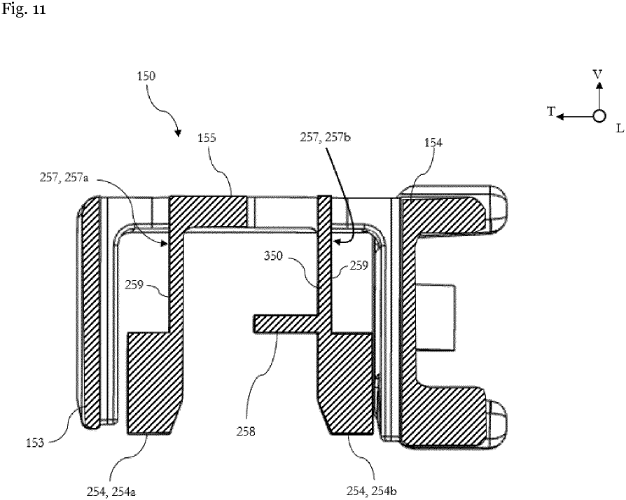

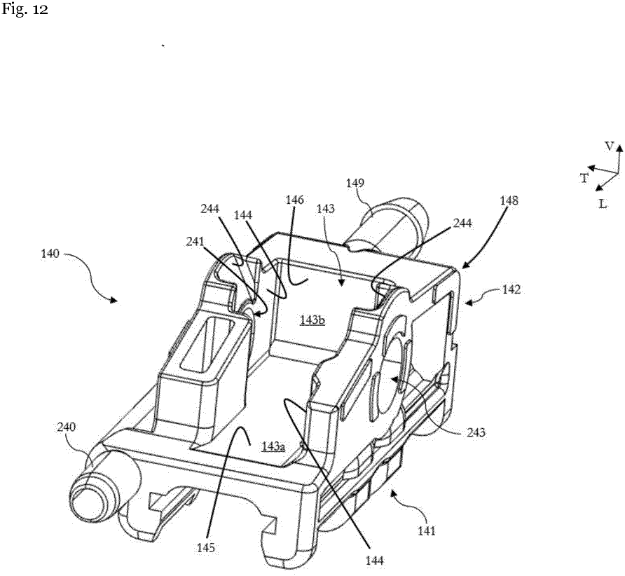

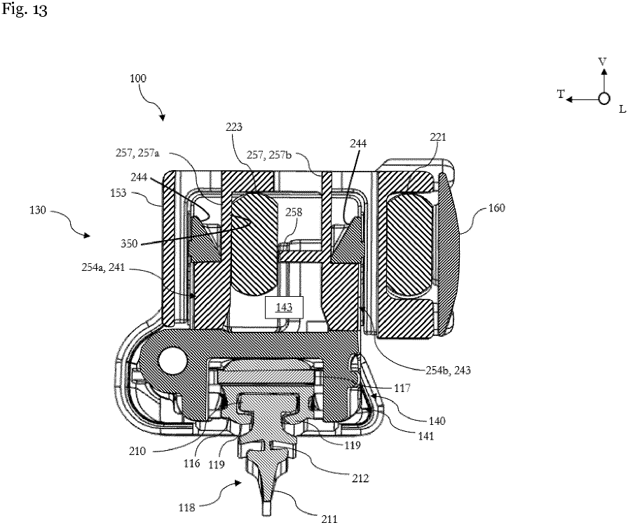

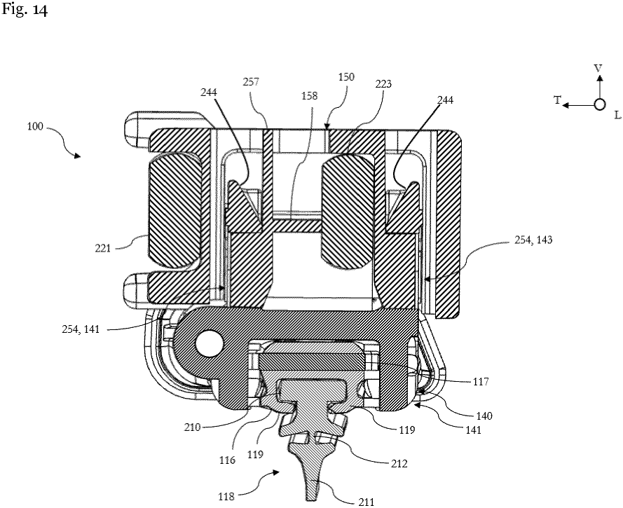

Further features, details and advantages will become more clearly apparent from reading the detailed description given below by way of indication and with reference to the various exemplary embodiments illustrated in the following figures:

[FIG. 1] illustrates a partial perspective view of a wiper system according to the invention, which comprises at least one wiper, one wiper arm and one connection device which connects the wiper arm to the wiper;

[FIG. 2] illustrates a perspective view of the connection device of the wiper system according to the invention, in which an adapter is illustrated in an exploded view;

[FIG. 3] illustrates a perspective view of the wiper arm according to the invention;

[FIG. 4] illustrates a perspective view of the adapter of the connection device according to a first exemplary embodiment of the invention;

[FIG. 5] illustrates a perspective bottom view of the adapter of the connection device according to the first exemplary embodiment illustrated in FIG. 4;

[FIG. 6] illustrates a perspective view of a connector of the connection device according to the first exemplary embodiment of the present invention;

[FIG. 7] illustrates a perspective view of the connection device according to the first exemplary embodiment of the present invention;

[FIG. 8] illustrates a view in longitudinal section of the wiper system according to the first exemplary embodiment of the present invention, this section being taken in a plane passing through the center of a hook forming an end of the wiper arm;

[FIG. 9] illustrates a first view in vertical section, taken in a plane passing through the connection device, of the wiper system according to the first exemplary embodiment of the present invention;

[FIG. 10] illustrates a second view in vertical section, taken in a plane passing through the connection device, this plane being different than the section plane in FIG. 9, of the wiper system according to the first exemplary embodiment of the present invention;

[FIG. 11] illustrates a view in vertical section of the adapter of the connection device according to a second exemplary embodiment of the invention;

[FIG. 12] illustrates a perspective view of the connector of the connection device according to the second exemplary embodiment of the present invention;

[FIG. 13] illustrates a view in vertical section, taken at the connection device, of the wiper system according to the second exemplary embodiment of the present invention;

[FIG. 14] illustrates a view in vertical section, taken at the connection device, of the wiper system according to a variant of the second exemplary embodiment of the present invention.

The features, variants and different embodiments of the invention may be combined with one another, in various combinations, provided that they are not mutually incompatible or exclusive. It will be possible, in particular, to imagine variants of the invention that comprise only a selection of the features described below, in isolation from the other features described, provided that this selection of features is sufficient to confer a technical advantage or to distinguish the invention from the prior art.

In the figures, the terms longitudinal, transverse, lateral, left, right, above, below refer to the orientation, with reference to a trihedron L, V, T, of a wiper 110 of a wiper system 100 according to the invention. Within this frame of reference, a longitudinal axis L represents a longitudinal direction, a transverse axis T represents a transverse direction, and a vertical axis V represents a vertical direction of the object in question. Within this frame of reference, a vertical section corresponds to a section taken in a transverse and vertical plane, that is to say in a plane in which the transverse axis T and the vertical axis V of the trihedron are inscribed. A longitudinal section for its part denotes a section taken in a longitudinal and vertical plane, that is to say a plane in which the longitudinal axis L and the vertical axis X are inscribed. In the following description, the terms “wiper” and “wiper blade” are used interchangeably, as are the terms “wiper arm” and “arm”.

FIG. 1 illustrates a wiper system 100 for wiping a glazed surface of a vehicle according to the invention. For example, the wiper system 100 may be intended to wipe a windshield of a motor vehicle. This wiper system 100 comprises at least one wiper 110 and at least one wiper arm 120 which are connected together by a connection device 130.

The wiper 110 extends mainly along a main extension axis X parallel to the longitudinal axis L of the trihedron illustrated and comprises at least one blade rubber 118 - visible for example in FIGS. 9, 10, 13 and 14 - designed to come into contact with the glazed surface so as to wipe it. The wiper 110 also comprises at least one stiffening member 117 - visible for example in FIGS. 8, 9, 10, 13 and 14 - and at least one air deflector 113 designed to convert a pressure applied by an air flow flowing along the glazed surface into a force pressing the wiper 110 against the glazed surface of the vehicle. The blade rubber 118, the stiffening member 117 and the air deflector 113 are carried by a support 116, visible in FIGS. 9, 10, 13 and 14, and these four elements are kept together, in part, by virtue of two terminal end pieces 115 - one of which is visible in FIG. 1 - which also have an aesthetic function.

The wiper arm 120 extends between a first end 121, by which it is connected to a motor carried by the vehicle and designed to drive this wiper arm 120 in rotation, and a second end 122, by which it is connected to the connection device 130.

More particularly, this connection device 130 comprises at least one connector 140 secured to the wiper 110 and an adapter 150 mounted so as to pivot on the connector 140. The second end 122 of the wiper arm 120 is more particularly secured to the adapter 150 of the connection device 130. This adapter 150 thus comprises at least one coupling tongue 151 which extends between a first end, by which it is secured to the adapter 150, and a second, free end, the second, free end comprising at least one holding member 152 for keeping the second end 122 of the wiper arm 120 in position. This coupling tongue 151 continues a side wall of the adapter 150. Consequently, a part of the second end 122 of the wiper arm 120 held by this coupling tongue 151 borders said side wall of the adapter 150.

The connection device 130 extends, longitudinally, between a front face 131 and a rear face 132, the rear face 132 facing the first end 121 of the wiper arm 120 and the front face 131 being face on the opposite side from this rear face 132, along the main extension axis X of the wiper 110. As will be described in greater detail below, the connector 140 and the adapter 150 define a housing of closed cross section designed to receive at least a part of the second end 122 of the wiper arm 120, this housing of closed cross section opening onto the front face 131 and/or onto the rear face 132 of the connection device 130. The connection device 130 and the elements that make it up will be described in greater detail later in the description.

The wiper system 100 illustrated in FIG. 1 also comprises at least one damping member 160 carried by the wiper arm 120, and more particularly by the second end 122 of this wiper arm 120. This damping member 160 is advantageously designed to limit the risks of damage to the glazed surface of the motor vehicle which incorporates the wiper system 100 according to the invention, in the case of poor manipulation of the wiper arm 120, for example during the replacement of the wiper 110, which would result in this wiper arm 120 dropping against the abovementioned glazed surface.

This FIG. 1 illustrates more particularly an embodiment variant of the wiper system 100 according to the invention in which the wiper 110 comprises at least one orifice for spraying a washer fluid - not visible here - designed to spray a washer fluid onto the glazed surface to which the wiper system 100 is dedicated. Advantageously, a plurality of orifices for spraying washer fluid are provided in the wiper 110. These spray orifices are for example distributed, along the wiper 110, on either side of the connection device 130. At least one channel for distributing this washer fluid to the spray orifices is also provided in the wiper 110. This distribution channel is supplied with washer fluid via the connection device 130. Thus, the presence of a duct 123 for conveying the washer fluid, which runs along the wiper arm 120 and is connected to the connection device 130 via its rear face 132, will be noted. Such a connection is made possible in particular by the shape adopted by the second end 122 of the wiper arm 120, described below with reference to FIG. 3. More particularly, the lateral positioning of a part of the wiper arm 120, along one side of the connection device 130, makes it possible to free up an upper part of the rear face 132 of the connection device 130, thereby allowing the connection of the conveying duct 123 to this rear face 132 of the connection device 130. This conveying duct 123 is kept in position against the wiper arm 120 by virtue of at least one retaining ring 124, advantageously several thereof.

FIG. 2 is an enlargement of a portion of the wiper system according to the invention, which comprises the connection device 130 and in which the adapter 150 is depicted in an exploded view in order to reveal a part of the housing of closed cross section which receives, partially, the second end 122 of the wiper arm. As depicted, this second end 122 has the shape of a flat hook 220, a segment of this flat hook 220 being received in the housing of closed cross section, that is to say inside the connection device 130. The term “flat hook” will be defined more fully below, with reference to FIG. 3. In the remainder of the description, the terms “flat hook” and “hook” will be used interchangeably.

Thus, at least a first segment 221 of the hook 220 forming the second end 122 of the wiper arm borders one side of the adapter 150 and a second segment 223 of this hook 220 is, for its part, received in the housing of closed cross section. In accordance with what was mentioned above, the first segment 221 of the hook 220 therefore forms the part of the second end 122 of the wiper arm 120 that borders 120 the connection device 130.

This FIG. 2 also reveals the hydraulic connection realized on the rear face 132 of the connection device 130. A first hydraulic connecting member 149 is provided on the rear face 132 of the connection device 130, and more particularly on a rear face 148 of the connector 140 of this connection device 130, the duct 123 for conveying the washer fluid being hydraulically connected to this first hydraulic connecting member 149.

FIG. 3 illustrates only the wiper arm 120. As mentioned above, this wiper arm 120 extends between a first end 121 and a second end 122. This wiper arm 120 comprises more particularly at least one rod 125 fitted in a yoke 126, itself secured for conjoint rotation to a bearing 127 connected to the motor carried by the vehicle. In other words, this bearing 127 forms the first end 121 of the wiper arm 120. This bearing 127 is designed to receive a drive shaft of the motor, this drive shaft being designed to drive the bearing 127, and consequently the whole of the wiper arm 120, in rotation.

The wiper arm 120 has two axes of rotation in the example illustrated. A main axis of rotation R1 is formed by the drive shaft of the motor designed to be received in the bearing 127 as has just been described. This main axis of rotation R₁ is substantially vertical, that is to say parallel to the vertical axis V of the trihedron illustrated, and perpendicular or substantially perpendicular to the glazed surface to be wiped. As a result, the wiper arm 120 is allowed to rotate, and therefore so is the wiper to which it is connected, in order to ensure that the it sweeps over the glazed surface of the vehicle which is equipped with the wiper system according to the invention. A secondary axis of rotation R2 is furthermore formed between the yoke 126 and the bearing 127. This secondary axis of rotation R2 is a transverse axis, that is to say parallel to the transverse axis T of the trihedron illustrated, and allows a vertical, or substantially vertical, movement of the rod 125 and of the yoke 126 with respect to the bearing 127. Such a movement makes it possible in particular to raise the second end 122 of the wiper arm 120 in order to move it away from the glazed surface in question, in order to replace the wiper to which the wiper arm 130 is connected when this is necessary.

For its part, as mentioned above, the second end 122 of the wiper arm 120 is in the form of a hook 220. According to the invention, this hook 220 has a flattened shape in the vertical direction as illustrated in FIG. 3. This flattened shape may be defined by the arrangement of a median plane of the hook 220, or of a radius of curvature of the curved part forming this hook 220. The median plane, or the radius of curvature, of the hook 220 is thus inscribed in a plane P perpendicular, or substantially perpendicular, to the main axis of rotation R1 of the wiper arm 120. As illustrated, the secondary axis of rotation R2 of the wiper arm 120 is inscribed in the plane P in which the radius of curvature of the hook 220 is also inscribed. In other words, this radius of curvature R is inscribed in a longitudinal and transverse plane, that is to say a plane in which the longitudinal axis L and the transverse axis T of the trihedron illustrated are inscribed.

This hook 220 is U-shaped, as seen from above, meaning that it comprises at least the first segment 221 which continues a main body 222 of this wiper arm 120 and at least the second segment 223 connected to the first segment 221 by a base 224. The first segment 221 of this hook 220 forms the part of the second end 122 of the wiper arm 120 that has been secured to the adapter by virtue of the coupling tongue, while the second segment 223 of this hook 220 is designed to be received in the connection device, and more particularly in the housing of closed cross section defined by the connector and by the adapter of this connection device. In other words, as mentioned above, the first segment 221 and the second segment 223 of this hook 220 can be distinguished from one another in that the first segment 221 borders, laterally, the connection device and in that the second segment 223 is received in this connection device.

It will be noted that the first segment 221 has a longitudinal dimension greater than a longitudinal dimension of the second segment 223 of the hook 220 forming the second end 122 of the wiper arm 120. The first segment 221 also has a least one first cutout 225 designed to receive a tooth which helps to form the holding member borne by the coupling tongue of the adapter and which will be described more fully below. According to the example illustrated, the first cutout 225 is a through-hole, but it will be understood that this is only one exemplary embodiment and this first cutout 225 could alternatively take the form of a blind hole without departing from the context of the present invention. According to this alternative, the blind hole opens onto an internal face of the first segment 221, that is to say a face of this first segment 221 that faces the second segment 223. The first segment 221 lastly comprises at least one second cutout 226, and in particular, according to the example illustrated, two second cutouts 226, designed to allow the damping member to be secured to this first segment 221.

With reference to FIGS. 4 to 10, a first exemplary embodiment of the present invention will now be described, FIGS. 4 and 5 illustrating the adapter 150 of the connection device 130 according to the first exemplary embodiment, FIG. 6 illustrating the connector 140 of this connection device 130 according to the first exemplary embodiment, FIG. 7 illustrating the connection device 130, that is to say the adapter 150 mounted on the connector 140, and FIGS. 8 to 10 illustrating different sections through the wiper system 100 according to the first exemplary embodiment.

The adapter 150 according to the first exemplary embodiment of the invention comprises at least one first side wall 153 and at least one second side wall 154, which are connected together by an upper wall 155. The upper part 155 and the two side walls 153, 154 define an internal space 156 of the adapter 150. In other words, the adapter 150 has an inverted U shape as seen in a vertical plane. As depicted, the abovementioned coupling tongue 151 continues the second side wall toward the rear, that is to say away from the front face of the connection device. The upper wall 155 extends, laterally and away from the internal space 156, beyond the second side wall 154. The adapter 150 also comprises at least one lower wall 157 which extends from a lower edge 158 of the second side wall 154, that is to say an edge on the opposite side from the upper wall 155, laterally and away from the internal space 156. As a result, the second side wall 154, the upper wall 155 and the lower wall 157 define a receiving region 159 for the first segment of the hook. Advantageously, a height H of the second side wall 154, measured between the upper wall 155 and the lower wall 157 along a direction perpendicular to a main extension plane of the upper wall 155, is identical, or substantially identical, to a thickness of the second segment of the hook measured along the same direction when the wiper device is assembled.

As mentioned above, the coupling tongue 151 comprises at least one member 152 for holding the first segment of the hook. More particularly, this at least one holding member 152 is provided at a rear end of the coupling tongue 151, which extends at a distance from the upper wall 155 of the adapter. According to the examples illustrated here, this at least one holding member 152 comprises at least one tooth 250 designed to cooperate with the first cutout provided in the first segment of the hook and at least two fingers 251 which continue the coupling tongue 151 laterally. More particularly, these fingers 251 extend perpendicularly, or substantially perpendicularly, to a main extension plane of the coupling tongue 151. A first finger 251a thus extends from an upper edge 252 of the coupling tongue 151, away from the internal space 156 of the adapter 150, and a second tongue 251b for its part extends from a lower edge 253 of this coupling tongue 151, also away from the internal space 156 of this adapter 150. The “upper edge” and “lower edge” of the coupling tongue 151 are understood here to be two edges of this coupling tongue 151 that opposite one another along a vertical direction parallel to the vertical axis V of the trihedron illustrated, and respectively close to the upper wall and to the lower wall of the adapter. Advantageously, the tooth 250 is provided between the first finger 251a and the second finger 251b that are borne by the coupling tongue 151. As a result, in the mounted position, the first segment of the hook is sandwiched between the first finger 251a and the second finger 251b, which are disposed on either side of the first cutout. For example, the tooth 250 can cooperate with the first cutout in the first segment of the hook by snap-fastening.

This adapter 150 is mounted so as to pivot on the connector. To this end, pivoting means are distributed between the adapter 150 and the connector. For example, at least one lug may be provided on one or the other of the adapter 150 and the connector, and an orifice, suitable for receiving this at least one lug, is provided in the other of the adapter 150 and the connector. According to the example illustrated here, the adapter 150 bears at least one lug 254 designed to be received in an orifice provided in the connector. As depicted, this at least one lug 254 is provided on an internal face of the first side wall 153, that is to say a face of this first side wall 153 that faces the internal space 156 of the adapter 150. Advantageously, the lug 254 borne by the first side wall 153 is a first lug 254a and the adapter 150 comprises a second lug 254b borne by an internal face of the second side wall 154, that is to say the face of this second side wall 154 that faces the internal space 156 of the adapter 150. Each lug 254a, 254b forms a protrusion from a side wall 153, 154, which extends inside the internal space 156 toward the other lug 254a, 254b. According to the invention, the first lug 254a is designed to cooperate with a first orifice provided in the connector and the second lug 254b is designed to cooperate with a second orifice likewise provided in the connector. An axis passing through the first lug 254a and through the second lug 254b forms a pivot axis of the adapter 150 with respect to the connector.

It will also be noted that the adapter 150 comprises a front wall 255 which extends from the upper wall 155 and from the second side wall 154 of the adapter 150. This front wall 255 is more clearly visible for example in FIG. 5.

FIG. 5 illustrates a perspective bottom view of the adapter 150 according to the first exemplary embodiment. This FIG. 5 reveals in particular the second lug 254b borne by the internal face of the second side wall 154. Each of the lugs 254a, 254b has a chamber 351 provided on a lower face of the lug 254a, 254b in question, that is to say on a portion of this lug 254a, 254b that faces the wiper when the adapter 150 is mounted on the connector of the connection device. These chamfers 351 make it easier to mount the adapter 150 on the connector of the connection device.

As mentioned above, the adapter 150 also comprises a front wall 255. As illustrated in FIG. 5, this front wall 255 is curved, a radius of curvature of this front wall 255 being inscribed in a plane parallel to the main extension plane of the upper wall 155 of the adapter 150. This front wall 255 is continued, toward the rear, that is to say in the direction of the coupling tongue 151, by an intermediate wall 256. Advantageously, the front wall 255 extends over only a portion of a transverse dimension d1 of the adapter 150, that is to say a dimension of this adapter 150 that is measured parallel to the transverse axis T of the trihedron illustrated, between the first side wall 153 and the second side wall 154 of this adapter 150, so as to leave free at least a part of this dimension and thus allow the insertion of the second segment of the hook forming the second end of the wiper arm. It will also be noted that the front wall 255 and the intermediate wall 256 have a shape complementary to the shape of the hook forming the second end of the wiper arm. This particular shape may for example serve as an insertion guide for the hook, and more particularly for the second segment of this hook, and then the front wall 255 can form an insertion stop for this hook. As can be seen for example in FIG. 8, this front wall 255 is more particularly designed to form a stop for the base of the hook forming this second end of the wiper arm. In other words, it will be understood that this base of the hook 220 helps to form the front face of the connection device.

FIG. 6 illustrates the connector 140 of the connection device according to the first exemplary embodiment of the present invention. As depicted, this connector 140 comprises at least one base 141 designed to receive, at least, the blade rubber, the support and the stiffening member that were mentioned above. In other words, this base 141 forms the part of the connector 140 which makes it possible to secure it to the wiper. From this base 141 there extends a main body 142 of the connector 140, the main body 142 forming a vertical protuberance intended to cooperate with the adapter so as to form the connection device.

As depicted, a groove 143 is provided in this main body 142. According to the example illustrated, this groove 143 is more particularly provided substantially at a center of the main body 142 of this connector 140, along the transverse direction. This groove 143 is thus defined by two lateral sides 144, a lower side 145 and a rear side 146, these two lateral sides 144, the lower side 145 and the rear side 146 being formed by internal faces of the main body 142 of the connector 140, that is to say faces of this main body 142 that face the groove 143. In other words, the groove 143 is recessed into the thickness of the main body. This groove 143, defined by the lateral sides 144, the lower side 145 and the rear side 146 of the groove 143, helps to delimit the housing of closed cross section of the connection device. In other words, this groove 143 is designed to receive a part of the hook forming the second end of the wiper arm. More particularly, this groove 143 is designed to receive the second segment of the hook forming the second end of the wiper arm.

This connector 140 extends, longitudinally, between a front face 147, which helps to form the front face of the connection device, and a rear face 148, which helps to form the rear face of the connection device. According to the example illustrated here, the first hydraulic connecting member 149 is provided on the rear face 148 of the connector 140 and a second hydraulic connecting member 240 is provided on the front face 147 of this connector. Although not visible in FIG. 6, a third hydraulic connecting member may advantageously be provided on the rear face 148 of the connector 140. The first hydraulic connecting member 149 is designed to be hydraulically connected to the duct for conveying the washer fluid, meaning that it forms an inlet point for the washer fluid into the connection device. The second hydraulic connecting member 240 is, for its part, hydraulically connected to the channel for distributing this washer fluid that is provided along the wiper and allows the members for spraying this washer fluid to be fed, meaning that this second hydraulic connecting device 240 forms an outlet point through which the washer fluid leaves the connection device.

As mentioned above, a first orifice designed to receive the first lug of the adapter and a second orifice designed to receive the second lug of the adapter are formed on the connector 140. As will be described in greater detail below, the adapter is configured to cover the connector 140. With the lugs being provided on the internal faces of the side walls of this adapter, it will be understood that the orifices need to be provided in external faces of the connector 140. Thus, the first orifice - not visible in FIG. 6 - is formed in a first external side face of the main body 142 of the connector 140 and the second orifice 241, for its part, is formed in a second external side face 252 of the main body 142 of the connector 140. Advantageously, the first orifice and the second orifice 241 are aligned, meaning that they are provided along a straight line parallel to the transverse axis T of the trihedron illustrated. For example, the first orifice and the second orifice 241 may be blind holes.

FIG. 7 illustrates a perspective view of the connection device 130 according to the first exemplary embodiment. This FIG. 7 thus makes particularly visible the housing 170 of closed cross section designed to receive the second segment of the hook forming the second end of the wiper arm. The “housing of closed cross section” is understood to be a housing which has a cross section, as seen in a vertical plane, that is closed.

As mentioned above, this housing 170 of closed cross section opens, at least, onto the front face 131 of the connection device 130. In other words, this housing 170 of closed cross section is in the form of a tube with a cross section, as seen in the vertical plane, that is closed and irregular. The second segment of the hook forming the second end of the wiper arm can thus be inserted into the housing 170 of closed cross section via the front face 131 of the connection device 130 until it comes into abutment against the above-described front wall 155. Optionally, the housing 170 of closed cross section can also open onto the rear face of the connection device 130.

It will also be understood from this FIG. 7 that the housing 170 of closed cross section extends, at least in part, in the internal space 156 of the adapter 150.

FIG. 8 illustrates, partially, the wiper system 100 according to the first exemplary embodiment of the present invention, as seen in a longitudinal section taken on a median plane or the hook, passing through a center of the base 224 of the hook 220, that is to say a point of this base 224 at which the radius of curvature of the hook 220 is smallest. This FIG. 8 makes particularly visible the cooperation between the front wall 255 of the adapter 150 and the base 224 of the hook 220, and more particularly with a rear face 228 of this base 224, that is to say a face of this base 224 that faces the interior of the hook 220 and the first end of the wiper arm. As mentioned above, the housing 170 of closed cross section in which the second end of wiper arm is received, at least partially, opens onto the front face 131 of the connection device 130 such that the hook 220 can be inserted into the housing 170 of close cross section via this front face 131 until the rear face 228 of the base 224 of this hook 220 is arranged in abutment against the front wall 255 of the adapter 150. In other words, in the mounted position, the base 224 of the hook 220 is arranged next to the front face 131 of the connection device 130.

It will also be noted that, according to the first exemplary embodiment illustrated here, the upper wall 155 of the adapter 150 extends, forwardly, beyond the front wall 255 so as to cover the base 224 of the hook 220 forming the second end of the wiper arm.

This FIG. 8 also reveals the hydraulic connection created between the first hydraulic connecting member 149 provided on the rear face 148 of the connector and the duct 123 for conveying the washer fluid. The first hydraulic connecting member 149 is thus fitted in the duct 123 for conveying the washer fluid.

FIG. 9 illustrates the wiper system 100 according to the first exemplary embodiment of the present invention, as seen in a vertical section taken on a plane passing through the connection device 130, through the first segment 221 and through the second segment 223 of the hook 220 forming the second end of the wiper arm.

As mentioned above, the adapter 150 is mounted so as to cover, at least partially, the connector 140. This results in the creation of the housing 170 of closed cross section which receives, as illustrated for example in this FIG. 9, the second segment 23 of the hook forming the second end of the wiper arm. More particularly, this housing 170 of closed cross section is defined by the first side wall 153 of the adapter 150, the upper wall 155 of this adapter 150, the second side wall 154 of the adapter, and by the main body 142 of the connector 140, that is to say by the groove 143 as defined above and by an upper face 242 of the main body 142 of the connector 140, that is to say a face of this main body 142 that faces the upper wall 155 of the adapter 150 when this adapter 150 is mounted on the connector 140. As mentioned above, the housing 170 of closed cross section extends in the internal space 156 of the adapter 150.

The second segment 223 of the hook of the wiper arm is thus received both in the internal space 156 of the adapter 150 and in the groove 143 provided in the connector 140. The first segment 221 of this hook, for its part, bears against the second side wall 154 of the adapter 150. As depicted, this second side wall 154 of the adapter 150 is thus sandwiched between the first segment 221 of the hook and the main body 142 of the connector 140. Such an arrangement advantageously makes it possible to ensure that the first lug and the second lug, respectively borne by the first side wall 153 and by the second side wall 154 of the adapter 150, are kept in the first orifice and in the second orifice, respectively, which, for their part, are provided in the external side faces of the main body 142 of the connector ₁₄₀.

According to this arrangement, the second segment 223 of the hook of the wiper arm is received in the groove 143 provided in the connector 140, while the first segment 221 of this hook borders, laterally, the connection device 130. Thus, if the first lug borne by the first side wall 153 of the adapter 150 starts to disengage from the first orifice that receives it, the second segment 223 of the hook is driven in the direction of this first side wall 153, until it comes into abutment against a lateral side 144 of the groove 143, thereby preventing full disengagement of this first lug from the first orifice. Analogously, if the second lug borne by the second side wall 154 starts to disengage from the second orifice that receives it, the second segment 223 of the hook is driven in the direction of this second side wall 154, until it comes into abutment against another lateral side 144 of the groove 143, thereby likewise preventing full disengagement of the second lug from the second orifice. The second segment 223 of the hook therefore helps to keep the lugs in their respective orifices and therefore, likewise, to keep the adapter 150 on the connector 140.

The cooperation of the first lug with the first orifice and of the second lug with the second orifice is illustrated for example in FIG. 10.

Moreover, FIG. 9 reveals a portion of the intermediate wall 256 which continues the front wall of the adapter. This intermediate wall 256 extends from the upper wall 155 of the adapter 150, in the internal space 156, and along a direction perpendicular, or substantially perpendicular, to the main extension plane of the upper wall 155 of this adapter 150. This intermediate wall 256 is separate from the first side wall 153 and from the second side wall 154 of the adapter 150. According to the first exemplary embodiment illustrated in FIG. 9, this intermediate wall 256 is thus a vertical tab which forms a member for guiding the second segment 223 of the hook 220 of the wiper arm, during the insertion of the latter into the housing 170 of closed cross section.

As mentioned above, the base 141 of the connector 140 forms the part of this connector 140 by which the latter is secured to the wiper. Thus, this base 141 has an overall inverted U shape which forms a space for receiving the support 116 bearing the stiffening member 117 and the blade rubber 118. More particularly, the stiffening member 117 is in the form of a metal strip received in a housing provided in the support 116. This support 116 also comprises at least two coupling tabs 119 for the blade rubber 118. This blade rubber 118 comprises at least one heel 210 which forms the part of the blade rubber 118 that is held by the two coupling tabs 119 of the support 116 and at least one wiping lip 211 connected to the heel 210 by a hinge 212, this wiping lip 211 forming the part of the blade rubber 118 that is designed to come into contact with the glazed surface to be wiped. This FIG. 9 reveals an intermediate channel 213 which is provided in the base 141 of the connector 140 and makes it possible to convey the washer fluid to the abovementioned distribution channel, which itself supplies the spray orifices provided in the wiper 110. In other words, this intermediate channel 213 is connected both to the first hydraulic connecting member and to the second hydraulic connecting member.

Lastly, this FIG. 9 reveals the damping member 160 carried by the first segment 221 of the hook 220. As depicted, this damping member 160 comprises a lower protrusion 161, meaning that a portion of this damping member 160 extends from a lower edge of this damping member 160, in the direction of the second side wall 154 of the adapter 150 when the damping member 160 is mounted on this first segment 221. This lower protrusion 161 is thus arranged next to a lower edge of the first segment 221. Optionally, the damping member 160 may comprise an air deflector, making it possible to further improve the aerodynamic performance of the wiper system according to the invention. Advantageously, the damping member 160 may also comprise at least one spray nozzle hydraulically connected to at least one cannula, this cannula being itself hydraulically connected to the above-described conveying duct.

According to one embodiment variant of the invention that is not illustrated here, the damping member covers the first segment of the hook forming the second end of the wiper arm, and also the base of this hook. The parts of the wiper arm that are furthest away from the secondary axis of rotation of this wiper arm form the parts of this arm that are most likely to come into contact with the glazed surface, and to damage it. Moreover, of the parts that are furthest away from this secondary axis of rotation, the parts that are not received in the connection device, that is to say the first segment and the base of the hook, are even more at risk. It is therefore important, according to the invention, that at least the base and/or the first segment of the hook is/are equipped with the damping member.

FIG. 10 illustrates the wiper system 100 according to the first exemplary embodiment in another vertical section taken on a plane passing through the connection device 130 and through, only, the first segment 221 of the hook, that is to say a section taken closer to the rear face of the connection device 130 than the section illustrated in FIG. 9.

This FIG. 10 thus makes particularly visible the cooperation between the first lug 254a and the first orifice 243, which are formed respectively on the first side wall 153 of the adapter 150 and in the connector 140, and between the second lug 254b and the second orifice 241, which, for their part, are formed respectively on the second side wall 154 of the adapter 150 and in the connector 140. It will be understood from this FIG. 10 that the side walls 153, 154 of the adapter 150 need to be spaced apart so as to allow this adapter 150 to be mounted on the connector 140. This mounting is also made easier by the presence of the chamfers on the lower faces of the lugs 254a, 254b that were described with reference to FIG. 5. These side walls 153, 154 thus exhibit sufficient elasticity to allow the insertion of the lugs 254a, 254b into the corresponding orifices 241, 243 when they return to their initial position. During the assembly of the arm on the connection device 130, once the hook has been inserted into the housing of closed cross section formed within the connection device 130, at least the first segment 221 of this hook makes it possible to press the second side wall 154 against the connector 140, and more particularly against the main body 142 of this connector 140, thereby ensuring that at least the second lug 254b is kept in the corresponding orifice. Likewise, as described with reference to FIG. 9, the lateral sides of the groove provided in the connector are designed to form a stop for the second segment of the hook received in the housing of closed cross section so as to prevent the disengagement of the lugs 254a, 254b from the orifices 241, 243 that receive them.

This FIG. 10 also reveals another portion of the intermediate channel 213 which extends through the main body 142 of the connector 140. This intermediate channel 213 thus passes, longitudinally, through the connection device in order to supply the washer fluid distribution channel.

Lastly, this FIG. 10 illustrates the means employed to keep the damping member 160 on the first segment 221 of the hook. As depicted, this damping member 160 thus comprises a pin 162 which extends from an internal face of the damping member 160, that is to say the face of this damping member 160 that is intended to come into contact with the first flank 221 of the hook, perpendicularly to a main extension plane of this internal face of the damping member 160. This pin 162 is received in one of the second cutouts 226 provided in the first segment 221 of the hook 220 and ends with a head 163 which forms a stop at an internal face of this first segment 221, that is to say a face that faces the second segment of the hook, which, for its part, is received in the housing of closed cross section. The head 163 has elastic deformation properties allowing it to be force-fitted in the corresponding second cutout 226, and its return to its original shape then forms a stop with respect to disengagement, locking the damping member 160 in position. More particularly, it will be noted that this internal face of the first segment 221 has an indentation 227 which is provided around the second cutout 226 in question and which receives this head 163 of the pin 162. Advantageously, this indentation 227 makes it possible to reduce the transverse size of the assembly made up of the first segment 221 and the damping member 160 that it carries, such that this first segment 221 can be engaged in the receiving region 159, along the adapter 150, provided to this end. It will be understood that this is only one implementation example of the invention and that the damping member could be secured to the wiper arm by any other known means that is compatible with the invention. For example, the damping member could be adhesively bonded or ultrasonically welded to the wiper arm, without departing from the context of the present invention.

A second exemplary embodiment of the present invention will now be described with reference to FIGS. 11 to 14. The elements that are identical in these different exemplary embodiments bear the same references, and for the description thereof, reference is made to the description already given above.

FIG. 11 thus illustrates the adapter 150 of the connection device according to the second exemplary embodiment of the invention. More particularly, this FIG. 11 illustrates a vertical section through this adapter 150 taken in a vertical plane passing through the lugs 254 which help to form the pivoting means employed between the adapter 150 and the connector of the connection device. The adapter 150 according to this second exemplary embodiment differs from the first exemplary embodiment in particular via the positioning of the lugs 254 which help to form the pivoting means employed between the adapter 150 and the connector 140.

Thus, according to this second exemplary embodiment, at least one tab 257 extends from the upper wall 155 of the adapter 150, in a direction perpendicular, or substantially perpendicular, to the main extension plane of this upper wall 155. According to the example illustrated, two tabs 257 extend from the upper wall 155, perpendicularly to the main extension plane of this upper wall 155 and in the internal space 156 of the adapter 150. Each of these tabs 257 bears one of the abovementioned lugs 254. Thus, a first tab 257a bears the first lug 154a designed to cooperate with the first orifice of the connector and a second tab 257b bears the second lug 254b designed to cooperate with the second orifice of the connector. More particularly, these lugs 254 each form a terminal part of the tab 257 that bears them. In other words, each tab 257 extends vertically between the upper wall 155 of the adapter 150 and the lug 254 that it bears. Each lug 254 is also arranged so as to protrude from an external face 259 of the tab 257 that bears it, that is to say a face of the tab 257 in question that faces away from the other tab 257.

Moreover, at least one of the tabs 257 has a rod 258 which extends from the tab 257 in question, and more particularly from an internal face 350 of the tab 257 in question, in the direction of the other tab 257, along a direction transverse, advantageously perpendicular, to a main extension plane of the tab 257 in question. In other words, this rod 258 extends mostly in a plane parallel, or substantially parallel, to the main extension plane of the upper wall 155 of the adapter 150. The “internal face 350 of the tab 257” is understood to be a face of this tab that faces the other tab. As will be described in greater detail below with reference to FIG. 13, the second segment of the hook forming the second end of the wiper arm is designed to come to bear against this rod 258, this bearing making it possible to keep the lug 254 borne by the tab 257 bearing this rod 258 in the corresponding orifice.

According to the example illustrated, the rod 258 is provided on the first tab 257a, but it will be understood that this is only one exemplary embodiment and that this rod 258 could be borne by the second tab 257b without departing from the context of the present invention. Alternatively, each of the tabs 257 could bear its own rod 258, without departing from the context of the present invention.

Apart from the differences that have just been described, the adapter 150 according to the second exemplary embodiment is identical to the adapter 150 according to the first exemplary embodiment, and so the description thereof that is given above, in particular with reference to FIG. 4, applies mutatis mutandis to this second exemplary embodiment.

FIG. 12 illustrates a perspective view of the connector 140 according to the second exemplary embodiment of the present invention; The connector 140 according to the second exemplary embodiment of the present invention comprises the base 141 from which there extends the main body 142 of this connector 140, in which the groove 143 is provided. According to the second exemplary embodiment, the groove 143 is designed to receive, in addition to the second segment of the hook of the wiper arm, the two tabs of the adapter that bear lugs which help to form the means for pivoting this adapter on the connector 140. As a result, the groove 143 according to the second exemplary embodiment has a transverse dimension, that is to say a dimension measured parallel to the transverse axis T of the trihedron illustrated, between the two lateral sides 144 which help to delimit this groove 143, which varies longitudinally. Thus, the transverse dimension of a first portion 143a of the groove 143 situated in the vicinity of the part of the connector 140 which helps to form the front face of the connection device is smaller than the transverse dimension of a second portion 143b of this groove 143, which is situated closer to the rear face 148 of this connector 140. The first portion 143a of the groove 143 is intended to receive, only, a portion of the second segment of the hook of the wiper arm, while the second portion 143b is, for its part, designed to receive another portion of this second segment of the hook of the wiper arm, and the tabs of the adapter that bear the lugs.

The connector 140 according to the second exemplary embodiment comprises, just like the connector according to the first exemplary embodiment, two orifices 241, 243 that are designed to receive the lugs borne by the adapter. As illustrated, these orifices 241, 243 are formed on the external side faces of the main body 142 of the connector 140. According to the second exemplary embodiment of the invention, the lugs are designed to be received in the groove 143. In order to allow the cooperation between these lugs and the orifices 241, 243, the latter are through-orifices, meaning that they are formed through the main body, respectively, from an external side face to the groove 143, and more particularly a lateral side 144 of this groove 143. In order to allow the insertion of the lugs into these orifices 241, 243, a chamfer 244 is provided, on the lateral side 144 in question, above each of these orifices 241, 243.

The rest of the connector 140 is identical between the first and second exemplary embodiments and the description thereof that is given above, in particular with reference to FIG. 6, applies mutatis mutandis to FIG. 12.

FIG. 13 illustrates the wiper system 100 according to the second exemplary embodiment of the present invention, shown in a vertical section taken on a plane passing through the two tabs 257 and through the rod 258 borne by one of these tabs 257.

As depicted, the second segment 223 of the hook forming the second end of the wiper arm is arranged so as to bear against the first tab 257a and against the rod 258 borne by the second tab 257b. More particularly, the second segment 223 bears against the internal face 350 of the first tab 257a and against the free end of the rod 258. In other words, this second segment 223 is clamped, or sandwiched, between the internal face 350 of the first tab 257a and the rod 258 borne by the second tab 257b. As a result, this second segment 223 makes it possible to keep the first lug 254a and the second lug 254b in position in their respective orifices 241, 243. More particularly, the bearing of the second segment 223 of the hook makes it possible to prevent the transverse movement, that is to say the movement along the pivot axis of the adapter 150 with respect to the connector 140, of the pivoting means, that is to say the relative movement of a lug 254a, 254b with respect to the orifice 241, 243 in which it is received.

It will be understood from this FIG. 13 that the adapter 150 is designed to be mounted along a vertical direction on the connector 140. The chamfers 244 provided above the orifices 241, 243 allow deformation, toward one another, of the tabs 257 during this insertion. These tabs 257 also exhibit sufficient elasticity to allow them to return into their initial position once they have been inserted into the groove 143 and the lugs 254 are arranged next to their respective orifices 241, 243. During the assembly of the wiper arm and the connection device 130, the second segment 223 of the hook 220 is inserted into the housing of closed cross section formed between the adapter 150 and the connector 140, and comes into contact with one of the tabs and with the tab associated with the other tab. The second segment 221 of the hook 220 thus makes it possible to ensure the stability of the cooperation between these orifices 241, 243 and the lugs 254. The rest of the wiper system according to the second exemplary embodiment is identical to the wiper system according to the first exemplary embodiment, and so the description thereof that is given above with reference to FIGS. 9 and 10 applies mutatis mutandis to this second exemplary embodiment.

FIG. 14 illustrates the wiper system 100 according to a variant of the second exemplary embodiment of the invention, shown in a vertical section taken on a plane passing through the two tabs 257 and through the rod 258 of the adapter 150. This variant of the second exemplary embodiment differs from the second exemplary embodiment that has just been described in that it is the mirror image thereof. In other words, when they are mounted on one and the same vehicle, the coupling tongue 151 of the first segment 221 of the hook 220 of the wiper arm of the wiper system according to the second exemplary embodiment faces toward the front of the vehicle, with respect to a direction of movement of this vehicle, while it faces toward the rear of this vehicle when the wiper system 100 is realized according to the variant of the second exemplary embodiment.

The wiper system 100 according to the second exemplary embodiment is particularly suitable for being mounted on left-hand drive vehicles, while the wiper system 100 according to the variant of the second embodiment is particularly suitable for being mounted on right-hand drive vehicles.

It will be understood from the foregoing that, regardless of the embodiment implemented, the wiper arm is able to be mounted in the connection device by way of a single movement in longitudinal translation. Advantageously, the invention therefore makes it possible to avoid the need to incline the wiper with respect to the wiper arm in order to insert this wiper arm into the connection device. As a result of the movement in longitudinal translation that is carried out, the first segment of the hook borders one of the side walls of the adapter, and the second segment of this hook is, for its part, received in the connection device, allowing it to help to keep the pivoting means arranged between the adapter and the connector in position.

It will be understood from the foregoing that the present invention thus provides a wiper system in which the shape of the wiper arm makes it advantageously possible to reduce the vertical size of the connection device, and also to connect a duct for conveying washer fluid via the rear of this connection device, it being understood that the description that has just been given does not limit the scope of the present invention.

1. A connection device for a wiper system for wiping a glazed surface of a vehicle, configured to connect a wiper to a wiper arm configured to drive the wiper in rotation, the connection device comprising:
at least one connector configured to be secured to the wiper; and
at least one adapter mounted so as to pivot on the connector,
the connector comprising a base forming the part of the connector configured to secure it to the wiper and a main body forming a vertical protuberance intended to cooperate with the adapter in order to form the connection device, the adapter and the connector defining, together, a housing of closed cross section designed to receive at least one part of a second end of the wiper arm
wherein the connection device comprises a groove provided in the connector, this groove helping to delimit the housing of closed cross section configured to receive the at least one part of the second end of the wiper arm, the groove being recessed into the thickness of the main body of the connector.

2. The connection device as claimed in claim 1, which comprises means for pivoting the adapter with respect to the connector, the pivoting means comprising at least one lug provided on one of the adapter and the connector, this lug being received in an orifice provided in the other of the adapter and the connector .

3. The connection device as claimed in claim 1, wherein the adapter comprises at least one first side wall and at least one second side wall which are connected together by at least one upper wall, the first side wall, the second side wall and the upper wall defining an internal space in the adapter, in which, at least, a part of the connector is received.

4. The connection device as claimed in claim 2, wherein at least one tab extends from the upper wall of the adapter, into the internal space in the adapter and along a direction transverse to a main extension plane of the upper wall, this at least one tab bearing the at least one lug and this at least one tab being separate from the side walls of the adapter.

5. The connection device as claimed in claim 4, wherein the at least one tab comprises at least one rod which extends from the tab along a direction transverse to a main extension direction of the tab, the at least one part of the second end of the wiper arm designed to be received in the housing of closed cross section being designed to be arranged so as to bear against this rod.

6. The connection device as claimed in claim 3, wherein the adapter comprises at least one coupling tongue designed to receive a part of the wiper arm, this coupling tongue extending between a first end, by which it is secured to the adapter, and a second, free end.

7. A wiper system of a vehicle, comprising at least one wiper designed to wipe a glazed surface of the vehicle, at least one wiper arm designed to drive the wiper in rotation and at least one connection device as claimed in claim 1, which is designed to connect the wiper to the wiper arm.

8. The wiper system as claimed in claim 7, wherein the wiper arm extends between a first end designed to be connected to a motor carried by the vehicle and a second end designed to be secured to the adapter, the second end of the wiper arm has a hook shape, at least a part of the hook is received in the housing of closed cross section, and this at least one part of the hook helps to keep the adapter on the connector.

9. The wiper system as claimed in claim 8, wherein the wiper arm is configured to pivot about a main axis of rotation, and wherein the hook of the wiper arm has a radius of curvature which is inscribed in a plane perpendicular to the main axis of rotation of this wiper arm.

10. The wiper system as claimed claim 8, wherein the hook forming the second end of the wiper arm is in the shape of a U comprising at least one first segment and at least one second segment that are connected together by a base, the at least one first segment forming a continuation of a main body of the wiper arm and the at least one second segment forming a free end of the hook, the at least one part of the hook of the wiper arm that is received in the housing of closed cross section being formed, at least, by the second segment of the hook.

11. The wiper system as claimed in claim 10, wherein the connection device extends, mostly, between a front face and a rear face, the front face facing away from the first end of the wiper arm, and wherein the base of the hook of the wiper arm is arranged next to the front face of the connection device.

12. The wiper system as claimed in claim 8, wherein the connection device is as claimed in claim 3, wherein the internal space in the adapter receives at least the second segment of the hook of the wiper arm, and wherein the second side wall of the adapter is clamped between the connector and the first segment of the hook of the wiper arm .

13. The wiper system as claimed in claim 12, wherein the connection device is as claimed in claim 2, and wherein the second segment of the hook of the wiper arm helps to keep the lug in the orifice.

14. The wiper system as claimed in claim 13, wherein the at least one tab comprises at least one rod which extends from the tab along a direction transverse to a main extension direction of the tab, the second segment of the hook of the wiper arm being arranged so as to bear against this rod.

15. The wiper system as claimed in claim 1, comprising at least one damping member carried by the wiper arm.
